(19) United States
(12) Patent Application Publication
(10) Pub. No.: US 2012/0082964 A1
(43) Pub. Date: Apr. 5, 2012

(54) ENHANCED GRAPHOLOGICAL DETECTION OF DECEPTION USING CONTROL QUESTIONS

(76) Inventor: Michael Scott Weitzman, West Islip, NY (US)

(21) Appl. No.: 12/878,619

(22) Filed: Sep. 9, 2010

(51) Int. Cl. G09B 19/00

(52) U.S. Cl. 434/155

(57) ABSTRACT

A method for enhanced graphological detection of deception is disclosed, including collecting handwritten answers to control questions and test questions from a subject. In certain embodiments of the invention, the collection of answers is accomplished with a handwriting tablet that can provide digital output. Next, the control input is analyzed so as to generate control handwriting feature data, and the test input is analyzed so as to generate test handwriting feature data. Next, test handwriting feature data resembling control handwriting feature data is designated to be non-deception-related, and test handwriting feature data not resembling control handwriting feature data is designated to be potentially deception-related. Finally, potentially deception-related test handwriting feature data is analyzed using graphological analysis, thereby identifying deception-related test handwriting data, and deception data is generated therefrom. A system for executing the method is also disclosed, which in some embodiments is a computer system.

### FIELD

This invention relates to graphology, and more particularly to graphological detection of deception.

### BACKGROUND

Graphological detection of deception is the method of detecting detection in a subject's handwritten statement, through the use of handwriting analysis. The techniques of graphological detection originated from graphology, the study and analysis of an individual's handwriting. Graphology, sometimes referred to more commonly as handwriting analysis, gained prominence in the context of identifying and/or certifying an individual's handwriting, typically for the purpose of validating evidence, for example with issues of inheritance. Graphology is also used by experts when evaluating an individual's personality. Graphological evaluation of personality tends to be more accepted in Europe than in the United States.

Graphological detection of deception can analyze features of an individual's handwriting so as to detect instances of deception in an individual's handwritten statement. Such handwriting features can include, for example, the use of space, the size of the handwriting, zonal sizes in the writing, letter slant, connective forms, pressure applied in writing, whether the writing is printed or written in script, specific letter formations, and the form level of the writing. More than one hundred features of handwriting have been identified and classified for use in handwriting analysis.

Graphological detection can help interviewers find and/or eliminate deception from a subject's handwritten statements. Graphological detection is a useful tool for interviewers in many occupations, including federal investigators, police investigators, business owners who want truthful information about their employees, and any other type of interview or investigative setting.

As commonly used, graphology associates specific meanings to particular features or sets of features that appear in an individual's handwriting. Recent research has shown, however, that some features of handwriting can be rigorously correlated with genetic traits and/or physiological conditions or states. That is, genetic and/or physiological effects can contaminate an individual's handwriting and reduce the reliability of handwriting analysis for graphological detection of deception.

### SUMMARY

A method for graphological detection of deception by a subject is claimed that accounts for genetic, physiological, or other idiosyncratic features of the subject's handwriting to improve the reliability of graphological detection of deception. The method includes collecting control input from the subject, where the control input includes handwritten answers to control questions on a questionnaire. The control questions are intended to solicit information that can be objectively verified. The method in addition includes collecting test input from the subject, where the test input includes handwritten answers to test questions.

The control input and test input are analyzed, so as to generate control handwriting feature data and test handwriting feature data, respectively. Next, test handwriting feature data resembling control handwriting feature data is designated as non-deception-related test handwriting feature data. This step takes advantage of the control questions in an important way. This step enables a graphologist analyzing the test answers to separate out handwriting features which represent nothing more than inherent personality traits of the subject, and which do not represent deception.

In certain embodiments of the invention, the collection of input is accomplished with a handwriting tablet that can provide digital output. In some embodiments, comparing test handwriting feature data with control handwriting feature data includes determining averages and standard deviations for counts of particular features tabulated in the control handwriting feature data and in the test handwriting feature data.

The particular features can include size of the letters, the slant of particular letters, and the amount of pressure applied during writing. In various embodiments, the method includes producing a report, the report including generated deception data that includes specific instances of dishonesty. In some embodiments, a computer system to implement methods of the present invention is provided.

In certain embodiments, the control input includes handwritten sentential answers to control questions on a questionnaire, and the test input includes handwritten sentential answers to test questions. In these embodiments, the sentential answers contain information in the grammar and words used that concerns possible deception by the subject. The method further includes generating test statement analysis data from analyzing sentential answers of test input, and processing the deception-related test handwriting feature data with the test statement analysis data to generate integrated deception data.

In one aspect of the invention, a method for enhanced graphological detection of deception by a subject is claimed, the method comprising: collecting control input from the subject, the control input including handwritten answers by the subject to control questions; collecting test input from the subject, the test input including handwritten answers by the subject to test questions; analyzing the control input to generate control handwriting feature data; analyzing the test input to generate test handwriting feature data; designating test handwriting feature data resembling control handwriting feature data to be non-deception-related test handwriting feature data; designating test handwriting feature data not resembling control handwriting feature data to be potentially deception-related test handwriting feature data; analyzing the potentially deception-related test handwriting feature data using graphological analysis, so as to identify deception-related test handwriting feature data; and generating deception data from the potentially deception-related test handwriting feature data.

In some embodiments, the generated deception data includes specific instances of dishonesty. In other embodiments, analyzing the control input includes identifying personality-based handwriting features. In other embodiments, the method further comprises collecting the control input and the test input through a paper form and/or an electronic writing tablet.

In other embodiments, control handwriting feature data and test handwriting feature data are generated based on a set of selected handwriting features, the set of selected features potentially including: use of space; size of handwriting including upper, middle, and lower zones; slant of the handwriting; connective forms of the handwriting; detection of a level of pressure applied during the handwriting; whether the individual prints or writes in script; specific letter formations in the handwriting; and form level of the handwriting.

In some embodiments, detection of the level of pressure includes determining a width measurement of a pen trace in handwritten answers to control questions and test questions. In other embodiments, test handwriting feature data resembling control handwriting feature data is identified by determining averages and standard deviations for counts of particular features tabulated in both the control handwriting feature data and in the test handwriting feature data. In some embodiments, the method further comprises producing a report, the report including generated deception data that includes specific instances of dishonesty.

In some embodiments, a method for enhanced graphological detection of deception by a subject is claimed, the method comprising: collecting control input from the subject, the control input including handwritten sentential answers by the subject to control questions; collecting test input from the subject, the test input including handwritten sentential answers by the subject to test questions; analyzing the control input to generate control handwriting feature data; analyzing the test input to generate test handwriting feature data; designating test handwriting feature data resembling control handwriting feature data to be non-deception-related test handwriting feature data; designating test handwriting feature data not resembling control handwriting feature data to be potentially deception-related test handwriting feature data; analyzing the potentially deception-related test handwriting feature data using graphological analysis, so as to identify deception-related test handwriting data; analyzing the sentential answers of the test input so as to generate test statement analysis data; and generating integrated deception data via integration of the deception-related test handwriting feature data with the test statement analysis data.

In some embodiments, the generated deception data includes specific instances of dishonesty. In other embodiments, analyzing the control input includes identifying personality-based handwriting features. In other embodiments, the method further comprises collecting the control input and the test input through a paper form and/or an electronic writing tablet.

In other embodiments, control handwriting feature data and test handwriting feature data are generated based on a set of selected handwriting features, the set of selected features potentially including: use of space; size of handwriting including upper, middle, and lower zones; slant of the handwriting; connective forms of the handwriting; detection of a level of pressure applied during the handwriting; whether the individual prints or writes in script; specific letter formations in the handwriting; and form level of the handwriting.

In some embodiments, detection of the level of pressure includes determining a width measurement of a pen trace in handwritten answers to control questions and test questions. In other embodiments, test handwriting feature data resembling control handwriting feature data is identified by determining averages and standard deviations for counts of particular features tabulated in both the control handwriting feature data and in the test handwriting feature data. In some embodiments, the method further comprises producing a report, the report including generated deception data that includes specific instances of dishonesty. In other embodiments, test statement analysis data is generated based on a set of selected attributes, the set of selected attributes including: language and syntax used by the subject in a statement; pronouns used by the subject in a statement; verb tenses used by the subject in a statement; order of the words in a statement of the subject; time references in a statement of the subject; specific words and phrases that indicate deception in a statement of the subject; whether the subject answered the question in his or her statement; whether the subject answered with a question in his or her statement; whether the subject crossed out words in a statement; unnecessary words in a statement of the subject; breakdown of a story in a statement of the subject; an omission in a statement made by the subject; and inconsistencies with and between verbal and written statements of the subject.

In some embodiments, a system for graphological detection of deception by a subject is claimed, the system comprising: a computing device, the computing device including: a controller configured to execute instructions; a memory coupled to the controller and configured to store instruction modules for execution by the controller; an input collection module coupled to the controller, the input collection module having instructions to collect control input and test input from a subject, the control input including handwritten answers to control questions and the test input including handwritten answers to test questions; an analysis module coupled to the controller, the analysis module having instructions to analyze control input to generate control handwriting feature data, and analyze test input to generate test handwriting feature data, the analysis module also capable of analyzing potentially deception-related handwriting feature data using graphological analysis, so as to identify deception-related handwriting feature data; a comparison module, the comparison module being coupled to the controller and having instructions to compare test handwriting feature data with control handwriting feature data, so as to designate test handwriting feature data resembling control handwriting feature data to be non-deception-related test handwriting feature data, and designate test handwriting feature data not resembling control handwriting feature data to be potentially deception-related test handwriting feature data; and a deception data generation module coupled to the controller and having instructions to process deception-related test handwriting feature data identified by the analysis module, so as to generate deception data; and an electronic handwriting input device coupled to the computing device, the electronic handwriting input device configured to electronically capture handwriting, the electronic handwriting input device including a scanner, and/or an electronic writing tablet capable of registering pressure applied in the handwriting.

In some embodiments, the system further comprises a report module coupled to the controller, the report module having instructions to produce a report, the report including generated deception data that includes specific instances of dishonesty. In some embodiments, the computing device includes a communication module, the communication module coupled to the controller, the communication module capable of providing communication between at least one of peripheral devices and a communications network; and a user interface coupled to the controller and including a keyboard input device, a pointing device, and a display device. In other embodiments, the electronic handwriting input device is coupled to the computing device via a communications network. In other embodiments, the computing device is a server, the server being coupled to the electronic handwriting input device via a client computing device.

In another embodiment, a system for graphological detection of deception by a subject is claimed, the system comprising: an electronic handwriting input device, the electronic handwriting input device configured to electronically capture handwriting of a subject; and a computing device coupled to the electronic handwriting input device, the computing device configured to: collect control input from the subject, the control input including handwritten answers by the subject to control questions; collect test input from the subject, the test input including handwritten answers by the subject to test questions; receive the control input and the test input from the electronic handwriting input device; analyze the control input to generate control handwriting feature data; analyze the test input to generate test handwriting feature data; designate test handwriting feature data resembling control handwriting feature data to be non-deception-related test handwriting feature data; designate test handwriting feature data not resembling control handwriting feature data to be potentially deception-related test handwriting feature data; analyze the potentially deception-related test handwriting feature data using graphological analysis, so as to identify deception-related test handwriting feature data; and generate deception data from the potentially deception-related test handwriting feature data.

In another embodiment, a system for graphological detection of deception by a subject is claimed, the system comprising: an electronic handwriting input device, the electronic handwriting input device configured to electronically capture handwriting of a subject; and a computing device coupled to the electronic handwriting input device, the computing device configured to: collect control input from the subject, the control input including handwritten answers by the subject to control questions; collect test input from the subject, the test input including handwritten answers by the subject to test questions; receive the control input and the test input from the electronic and writing input device; analyze the control input to generate control handwriting feature data; analyze the test input to generate test handwriting feature data; designate test handwriting feature data resembling control handwriting feature data to be non-deception-related test handwriting feature data; designate test handwriting feature data not resembling control handwriting feature data to be potentially deception-related test handwriting feature data; analyze the potentially deception-related test handwriting feature data using graphological analysis, so as to identify deception-related test handwriting feature data; and generate deception data from the potentially deception-related test handwriting feature data.

### BRIEF DESCRIPTION OF THE DRAWINGS

The invention will be more fully understood by reference to the detailed description, in conjunction with the accompanying figures, wherein:

FIG. 1A is a perspective view of a subject answering questions using an electronic writing tablet to record handwritten answers;

FIG. 1B is a perspective view of a subject answering questions using an electronic writing tablet to record handwritten answers, while an interviewer presents questions, takes notes, and records verbal statements of the subject;

FIG. 2 is an example questionnaire showing a subject's handwritten answers to control questions and test questions;

FIG. 2A is an example report describing specific instances of deception in a subject's handwriting;

FIG. 2B is an example report showing deception statistics in a subject's handwriting;

FIG. 3 is a table of features of handwriting on which analysis of control input and test input is based in an embodiment of the invention;

FIG. 4 is a flowchart of an embodiment of the method for enhanced graphological detection of a subject's deception;

FIG. 4A is a flowchart that provides further details about steps 406 and 408 in FIG. 4, in particular, how control input can be analyzed to generate control handwriting feature data, and test input can be analyzed to generate test handwriting feature data;

FIG. 4B is a flowchart that provides further details about step 410 in FIG. 4, in particular, determining which portion of test handwriting feature data resembles control handwriting feature data;

FIG. 5 is a flowchart of an embodiment of a method of the present invention that integrates statement analysis with handwriting analysis to generate integrated deception data;

FIG. 6 is a table of attributes of handwriting used when generating test statement analysis data; and

FIG. 7 is a block diagram of an embodiment of a system for graphological detection of deception, showing a computing device including a user interface and software modules, and a handwriting input device for capture of handwriting in response to questions, such as questions of an interviewer.

### DETAILED DESCRIPTION

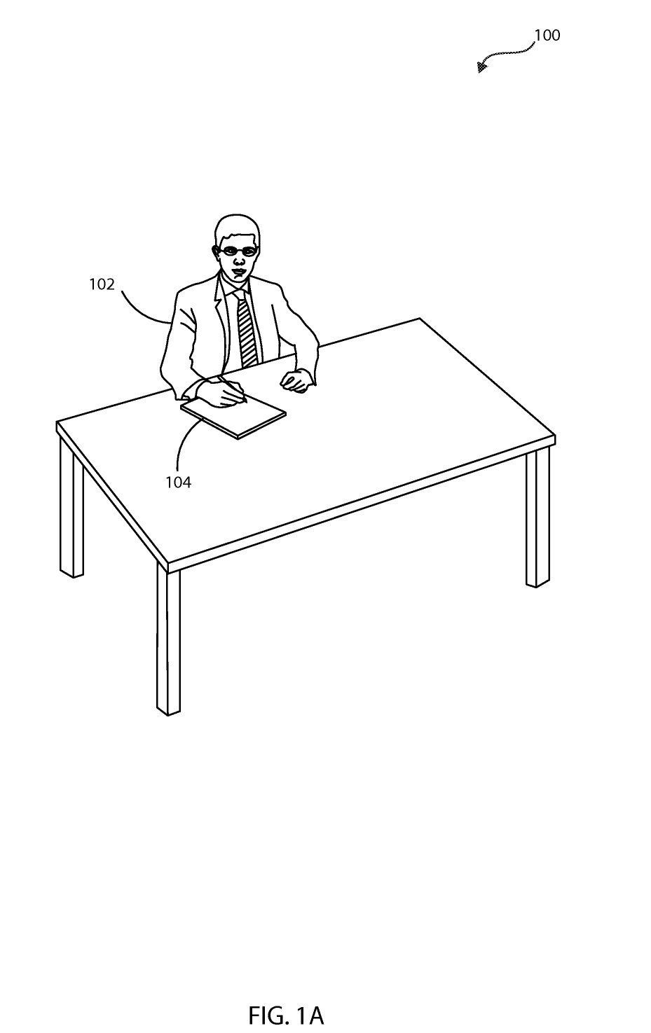

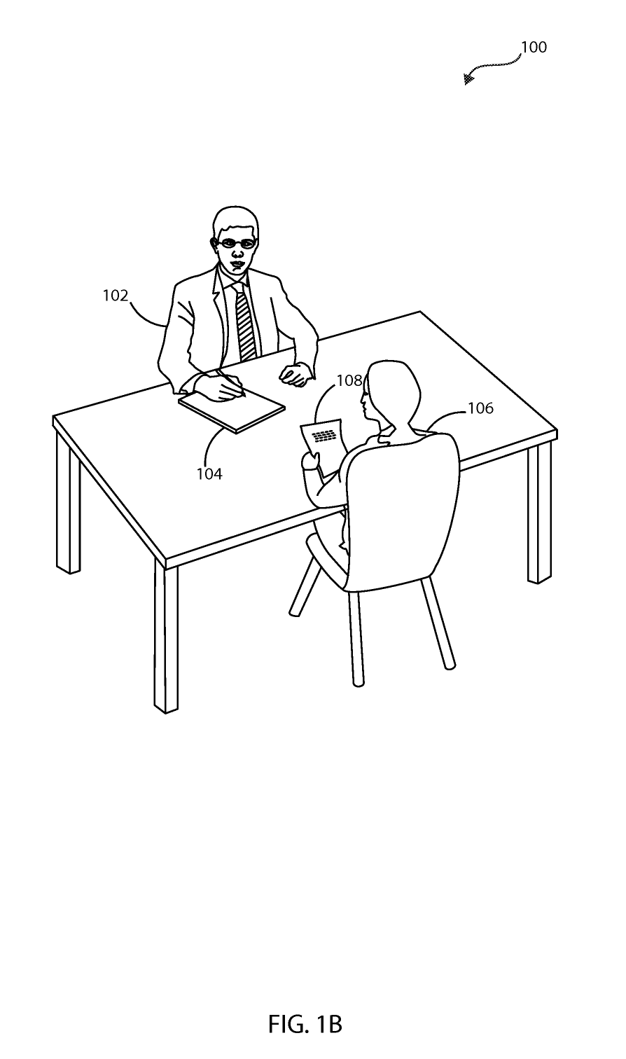

FIG. 1A is a perspective view of an questioning scenario 100 including a subject 102 answering questions using an electronic writing tablet 104 to record handwritten answers. The questionnaire may be displayed on a display on the writing tablet, on another display, or may be on paper. In the example shown in FIG. 1A, the questionnaire can be for the purpose of determining suitability of the subject 102 for a position with a company, for example.

The questions presented on the questionnaire are of two types. One type of question elicits responses from the subject 102 whose truth can be objectively determined, for example, the subject's name, address, educational history, and so on. A second type of question seeks information that cannot be readily verified. Instead, the information sought may be of particular interest in, for example, a hiring decision. Such information may include, for instance, past drug use or criminal history.

While FIG. 1A shows a subject 102 answering questions for a company to determine his suitability for employment, the methods and systems described herein can be applied to other scenarios. It will be appreciated that, for example, similar methods and systems can be used during investigation of an accident by federal, state, or local authorities. Additional examples of scenarios in which embodiments of the present invention can be used include criminal investigations and national security investigations, for example, an espionage investigation, or an interview for a security clearance. Other applications include investigative journalism, industrial espionage investigation, and other situations where deception is likely and/or may have bearing on conclusions drawn from a subject's responses.

In the context of filling out a questionnaire for employment, the subject 102 typically has previously presented documentation to support his fitness to fill a particular position. In this disclosure and in the accompanying claims, the subject 102 may also be referred to as a candidate or interviewee. In some instances the candidate 102 may have also undergone a telephone interview with, for example, a human resources representative or a hiring manager. Thus, in this scenario, particular questions may be posed that relate to information previously provided by the candidate.

In other contexts, the subject 102 may or may not have already provided an oral or written statement. For example, in the case of a traffic accident, a driver may have already provided a signed, written statement to local authorities. In criminal investigations as well, a signed, written statement may have been provided. In other contexts, no previous oral or written statements from the subject 102 that are relevant to detection of deception may be available.

As mentioned above, in method embodiments of the present invention, two distinct types of question are presented to the subject 102 on the questionnaire. The present invention differs from conventional applications of handwriting analysis where no distinction is made in the type of questions presented, or where a handwriting sample may be obtained in other ways.

In the present invention, a first type of question, referred to herein as control questions, solicits information from the subject 102 that can be objectively verified to be true. This information may include, for example, aspects of the previous work history of the subject 102, the subject's driver's license number, date of birth, and/or eligibility to work in the U.S.

A second type of question, herein referred to as test questions, targets information that cannot be readily verified, and/or can only be objectively verified with great difficulty, if at all. Nonetheless, the responses of the subject 102 to test questions may be of interest in, for example, hiring decisions, criminal investigations, or security clearance decisions. Besides past or current drug use and criminal history, this information may include names of acquaintances, whether the subject 102 is in possession of particular information, and/or details of the subject's whereabouts at particular times in the past.

Continuing with the description of FIG. 1A, the electronic writing tablet 104, also referred to herein as a handwriting tablet, may be a pressure sensitive device and used with a special stylus. Devices with the capability to record handwriting are well known. Such a handwriting tablet 104 could have, for example, a surface that includes an array of sensors that produce a signal in response to applied pressure. A device of this type with widespread use is a signature tablet as may be found at many retail merchants for capturing a credit card user's signature. In other embodiments, the subject 102 may write answers to questions in spaces provided on a paper copy of a questionnaire, without use of an electronic writing tablet 104.

The paper copy may then be scanned for subsequent analysis, or the analysis of the subject's handwriting can be carried out without use of a computer. In some embodiments, the paper questionnaire may be positioned on the handwriting tablet 104, and the responses of the subject 102 captured electronically as well as on the paper copy. It is understood that handwriting capture can be accomplished in a variety of ways without departing from the scope of this disclosure.

FIG. 1B is a perspective view of a questioning scenario 100 in the form of an interview in which the subject 102 is answering questions using an electronic writing tablet 104 to record handwritten answers, while an interviewer 106 presents questions 106. In the example shown in FIG. 1B, an interview 100 can be for the purpose of determining suitability of the subject 102 for a position with a company. The previous discussion in connection with FIG. 1A therefore applies as well to FIG. 1B, for example in the two types of questions presented, in the nature of the information sought, and in the use of a handwriting tablet in certain embodiments. FIG. 1B differs from FIG. 1A in that the interviewer 106 is present to observe and interact with the subject 102 and to present questions verbally. The interviewer 106 may also take notes, and in addition may also record verbal statements of the subject 102 with a speech recorder (not shown).

The interviewer 106 can be, for example, a member of a human resources department, or a contractor hired by a company to carry out such interviews. In other scenarios, for example, those involving investigative agencies, the interviewer 106 would be affiliated with the investigative agency. Typically, the interviewer 106 is trained in interview techniques, as well as handwriting analysis and statement analysis.

In the context of an employment interview 100, the interviewee 102 typically has previously presented documentation to support his fitness to fill a particular position. In some instances the interviewee 102 may have also undergone a telephone interview with, for example, a human resources representative or a hiring manager. Thus, in this scenario, particular questions may be posed that relate to information previously provided by the candidate.

Although capture of a subject's handwriting is shown in FIG. 1B in the context of an interview 100, it will be appreciated that for purposes of the methods described herein, such capture can take place without an accompanying interview (see FIG. 1A). It is understood that use of the term “subject” is more appropriate, rather than the term “interviewee,” in those situations in which the handwriting is captured outside an interview situation.

As briefly mentioned above, the interviewer 106 may also take notes. The notes may include, for example, descriptions of body language and demeanor of the subject 102, his style of dress, and other details that may be relevant to detection of deception but not captured in handwriting or speech. All of these aspects, handwritten answers, speech, and other details such as demeanor, provide information relevant to the veracity of the subject's answers. As well as handwriting and speech, the other aspects and details captured by the interviewer 106 may be used in subsequent analysis of the interview 100. It is understood that, while notes written by the interviewer can provide additional information useful to detection of deception, preferred embodiments of the present invention apply handwriting analysis to control input and test input captured in responses of a subject 102 to questions on a questionnaire to detect deception in the responses.

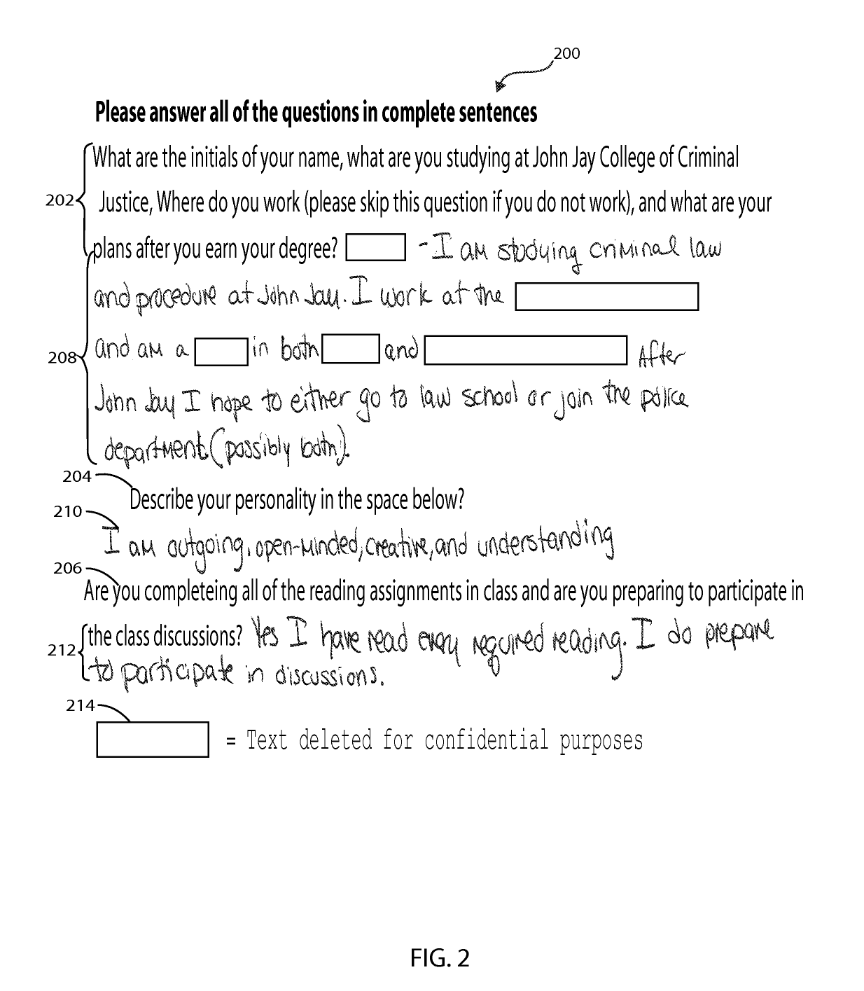

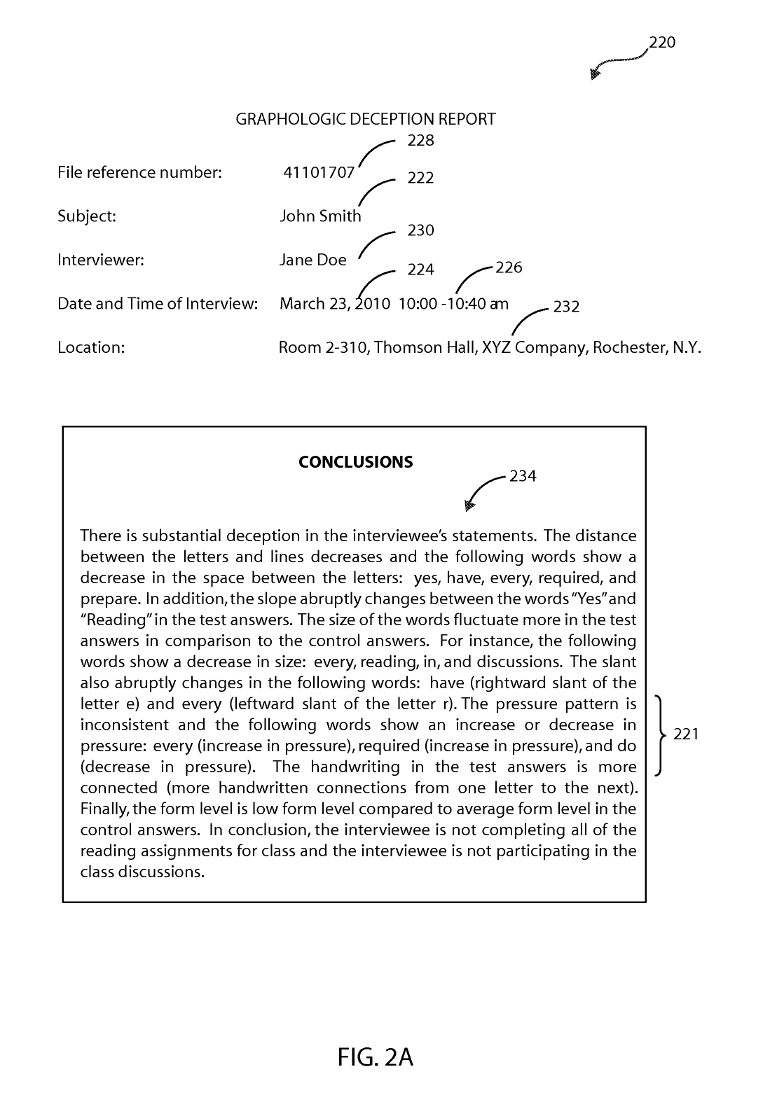

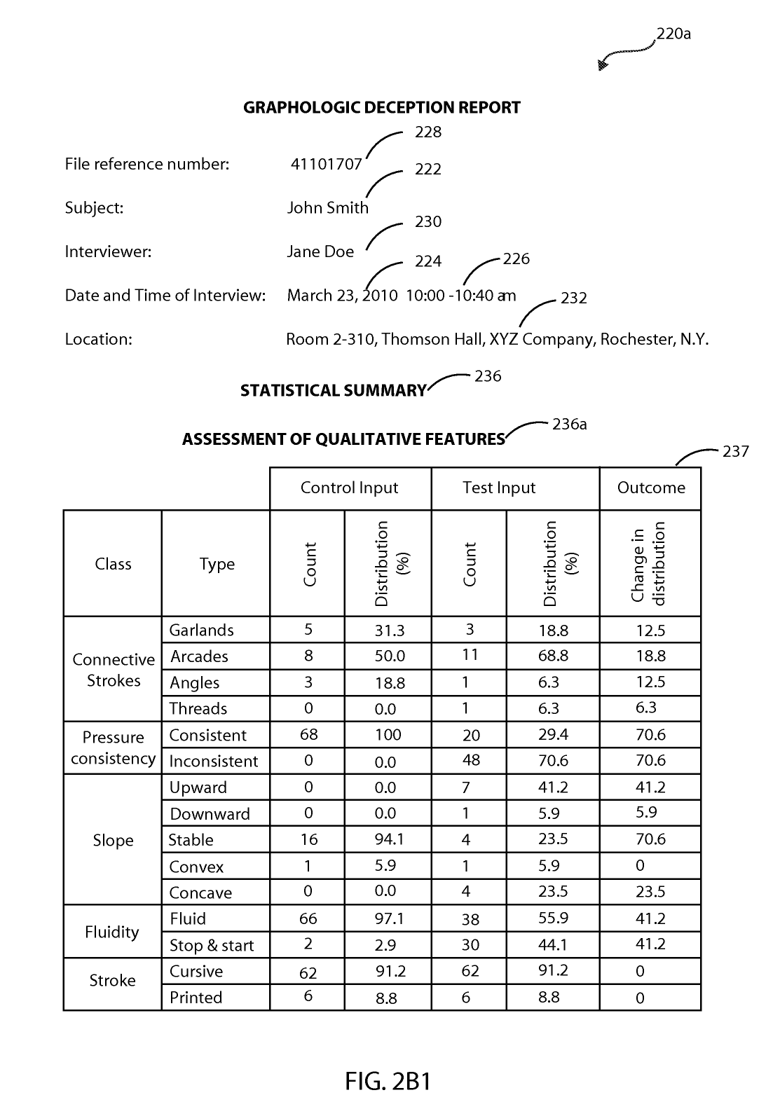

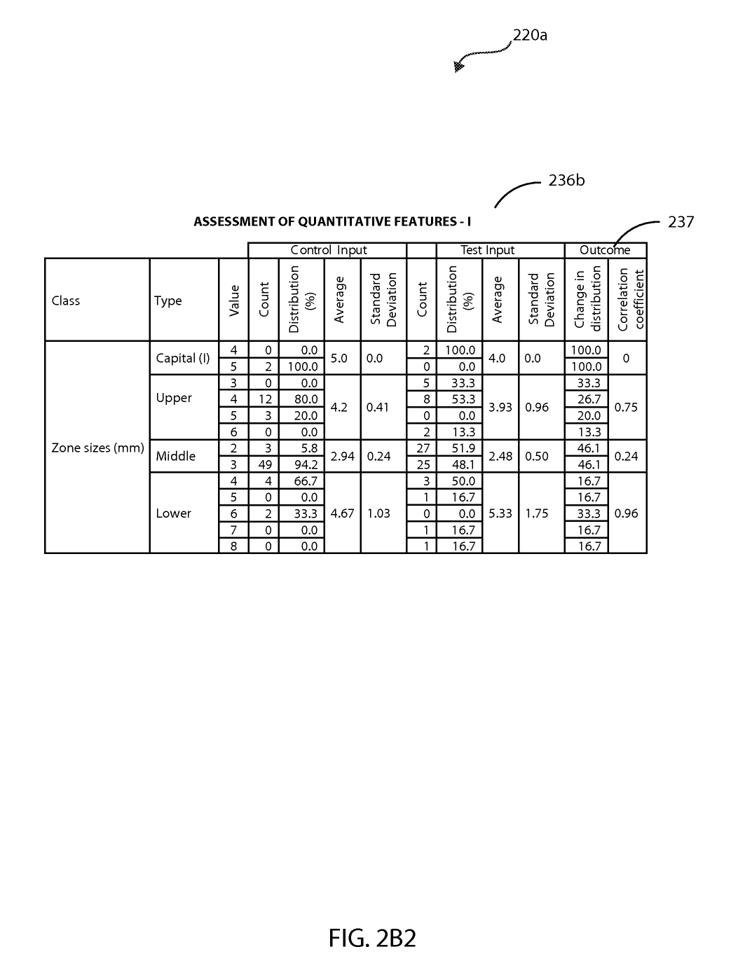

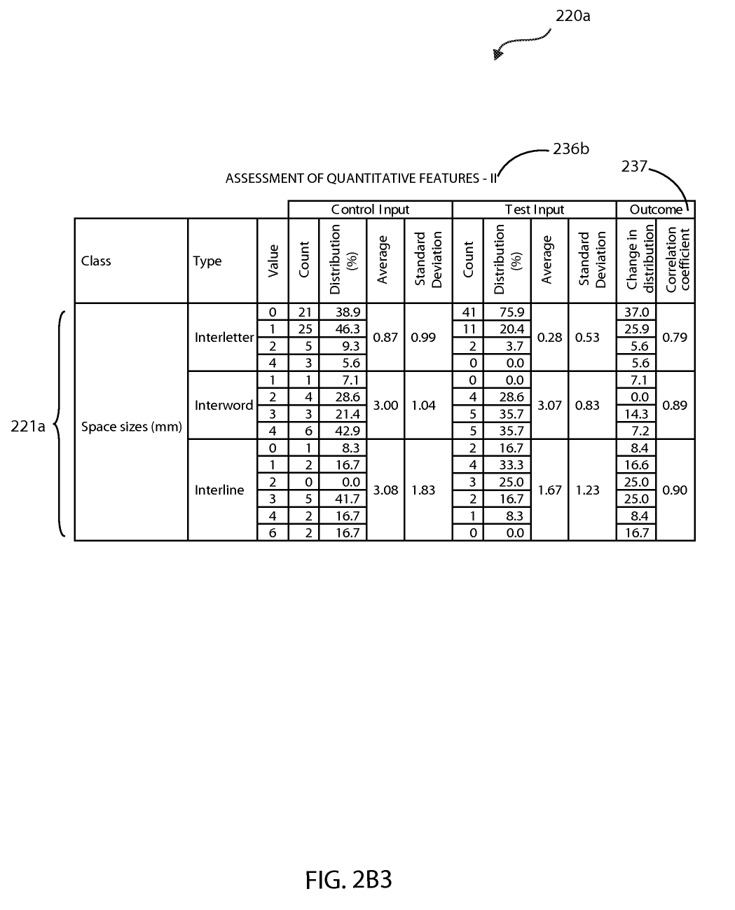

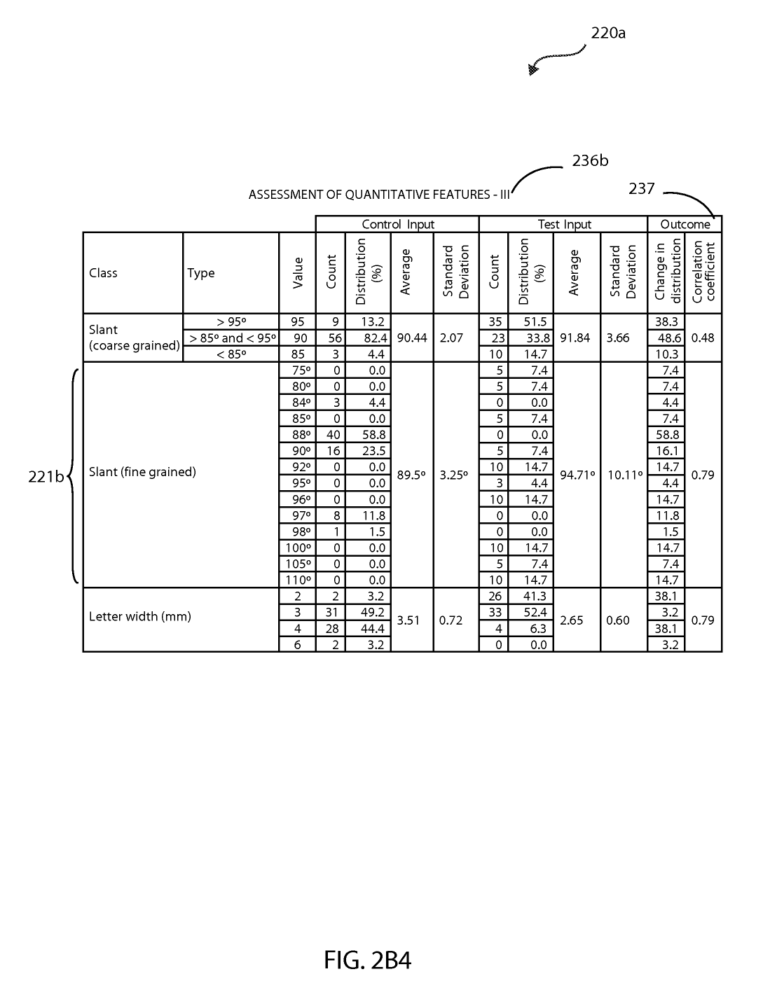

FIG. 2 is an example questionnaire 200 showing a subject's handwritten answers to control questions 202 and test questions 204, 206. Answers 208 provided by the subject to the first set of control questions 202 provide information that goes beyond graphological and textual information as customarily sought in conventional handwriting analysis. The control questions 202 are formulated to elicit information from the subject referred to herein as control input 208. The control questions 202 and their answers 208 may have little or no bearing on the actual intent of the interview, and are intended to be non-threatening to the subject 102. The non-threatening aspect of the control questions 202 can help promote comfort of the subject in answering the control questions.

The example questionnaire 200 shown in FIG. 2 was administered as part of a university classroom course. Since the answers include genuine responses 208, 210, and 212 of an individual, particular text has been deleted 216 to keep the example impersonal.

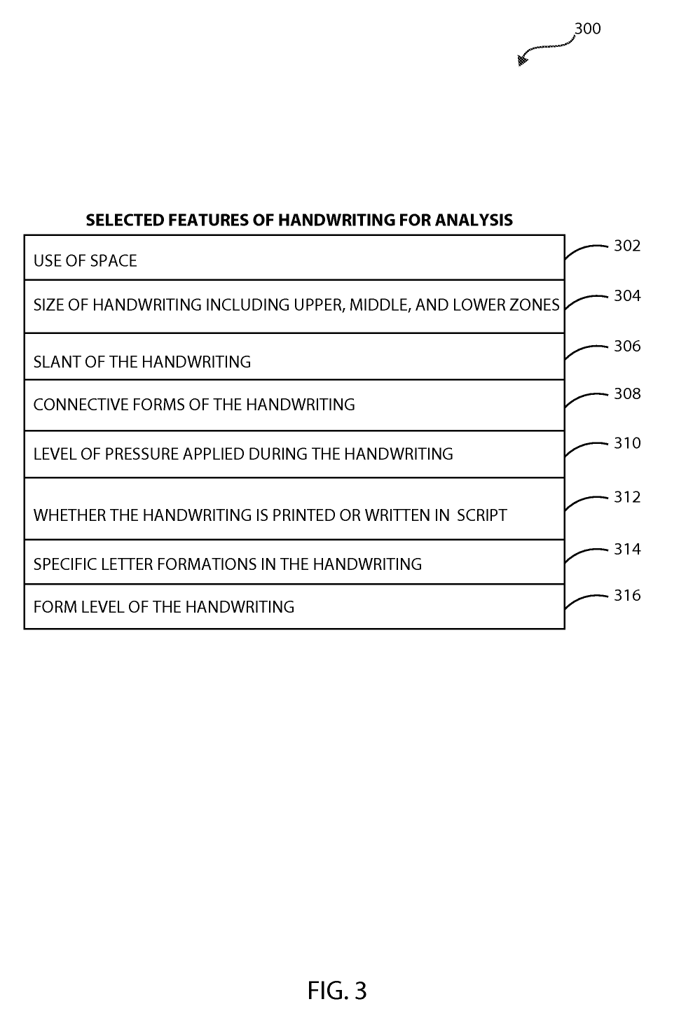

The purpose of the control questions 202 is to enable generation of control handwriting feature data for comparison of graphological features that subsequently appear in the subject's answers to the test questions 204, 206. The graphological features on which the control handwriting feature data is derived can include, for example, slant of the handwritten letters, or the pressure applied by the subject during handwriting of particular letters or words. The graphological features are discussed in more detail below in connection with FIG. 3.

The control handwriting feature data is used to interpret whether graphological features that show up in answers to test questions represent instances of deception, or instead represent idiosyncrasies of the subject. All individuals differ from the “norm” in one way or another, and this can be especially true in the case of handwriting. Therefore, one aspect of the invention is the establishment of control handwriting feature data, so that account of such individual differences can be taken.

While control questions 202 are posed to obtain handwritten responses for establishing control handwriting feature data, test questions 204, 206, on the other hand, seek information that is relevant with regard to the intent of the interview. In the sample questionnaire 202, the test questions 204, 206 solicit information regarding the subject's class work. Answers provided by the subject to the test questions 204, 206 provide the test input 210, 212. Information provided by the subject's answers 210 and 212 to the questions 204 and 206, respectively, may be important in a classroom scenario, for example, to guide an instructor's decision on grade assignment.

Other information may be important in some interview scenarios. For example, a subject's criminal record or résumë details may be part of the content of the test questions 204, 206. News articles in recent years have described, for example, instances of lying on résumës by individuals of prominence, that led to discharge or resigning of those individuals from their positions. It is readily apparent that test questions 204, 206 can be formulated to probe the veracity of a subject's assertions about résumë details or other past history of the subject. It will be appreciated that the questionnaire 202 of FIG. 2 is a sample questionnaire. In actual use, a questionnaire 202 may include a greater number of questions that cover a greater variety of areas of inquiry. It will also be appreciated that, because the questionnaire 202 is of limited scope, an example report of deception in responses to the questions 204, 206, and or specific instances of deception, derived from the example questionnaire, is also of limited scope, but can nevertheless be illustrative.

FIG. 2A is an example report 220 describing specific instances of deception in the handwriting sample of FIG. 2. A typical handwriting analysis report 220 may discuss, in turn, the flow of the handwriting, the amount of pressure applied 221, the use of space, and other aspects of the writing, in the context of analysis of the subject 102. But whereas conventional handwriting analysis, and its report, typically focuses on personality or on certifying an individual's handwriting, in embodiments of the present invention the focus of the handwriting analysis, and the handwriting analysis report 220, is on deception in the handwriting sample, and particularly on specific instances of deception.

The sample report 220 shown in FIG. 2A includes a subject's name 222, date 224 on which the handwriting sample was collected, time of the interview 226, file reference number 228, interviewer name 230, and may include additional reference information 232. Next follows a summary 234 of the conclusions, including identification of specific instances suggesting deception, for example, the words “every” and “required.”

FIG. 2A shows a Conclusions section which provides a summary conclusion 234 the findings from analyzing the control answers and test answers. One exemplary finding shown and labeled in the figure is that of the pressure patterns 221 of certain words in the test answers. Certain key differences between the control input and the test input have been observed and documented in the summary conclusion 234, such as: the spacing between letters and lines in test answers versus control answers; the degree of fluctuation in word size in test versus control answers; the connectivity of the lettering (script versus print) in test versus control answers; and the form level of the test answers versus control answers. These differences have a strong bearing on what is considered potentially deception-related data in the control answers, and they factor into whether or not a statement will be considered deceptive on any level.

Deception can be analyzed at the entire statement level, at the paragraph level, at the sentence level, and/or at the word level. In some instances, the entire statement may only be a paragraph or sentence. In the example shown in FIG. 2, the test answers are composed of statements 210, 212 that are each only one sentence long.

In analyzing the handwriting, statistical data including averages and standard deviations of characteristics throughout the handwriting may be determined with, for example, a computer program for graphological detection. However, in some instances it may not be necessary to use a computer program to compute averages and standard deviations because it may be obvious whether differences in handwritten characteristics between the control group and test group of answers represent honesty or deception.

FIGS. 2B1 through 2B4 is an example supplement 220a to the report 220 that includes statistical analysis of the handwriting sample of FIG. 2. FIG. 2B is divided into FIGS. 2B1, 2B2, 2B3, and 2B4. In the statistical summary 236, averages and standard deviations of characteristics throughout the handwriting may be determined with a computer program for graphological detection, although the invention may be practiced without use of a computer. In some instances it may not be necessary to use a computer program to compute averages and standard deviations because it may be obvious whether differences in handwritten characteristics between the control group and test group of answers represent honesty or deception.

As with the sample report 220 shown in FIG. 2A, the supplement 220a includes the subject's name, date on which the handwriting sample was collected, time of the interview, file reference number, interviewer name, and may include additional reference information (shown in FIG. 2B1). The statistical summary 236 of the supplement 220a includes an assessment of qualitative features and quantitative features. This statistical summary is used as an example statistical summary that might be used to represent the answers to the questionnaire 200.

Various handwriting features from both the control input and test input are assessed in a chart 237. The assessment of qualitative features 236a is presented in a portion of the chart 237 that is shown in FIG. 2B1. In this portion of the chart, various handwriting features are tallied up in both the answers to the control questions, as well as the answers to the test questions. For the purpose of this chart 237, qualitative features are handwriting features whose number of appearances is being counted, but which are not otherwise being measured in any other way.

The various qualitative handwriting features are grouped into various classes (connective strokes, pressure consistency, slope, fluidity, and stroke). Each of the features are counted up, and the percentage of their presence, versus the presence of other features of the same class, is measured in a Distribution Percentage section for both Control Input and Test Input columns. The Change in Distribution is listed in an Outcome column. This provides a quantification of the change in distribution of various handwriting features, relative to other features of the same class. This information helps the graphologist understand how a subject's handwriting in test answers differs from the control answers. For example, the change in distribution of consistent versus inconsistent pressure in the handwriting, from the control answer over to the test answers, was a change of 70.6 percent. This is a significant change to note, and has a strong bearing on whether the test answers generally, or specific portions of the test answers, are considered deceptive.

The assessment of quantitative features 236b is presented in the portions of the chart 237 shown in FIGS. 2B2, 2B3 and 2B4. For the purposes of the chart 237, quantitative features are handwriting features which are measured in some way beyond simply counting the number of appearances of the feature. For example, FIG. 2B2 shows measurements in millimeters of zonal sizes of letters and FIG. 2B3 shoes measurements in millimeters of space sizes between letters, words and lines. FIG. 2B4 records the degree of slant from the vertical of letters, as well as letter width in millimeters.

The chart for quantitative features includes a tabulation of feature counts in the sample, for the control input and for the test input separately, as well as averages (Ave) and standard deviations (SD), both at the word level and the sentence level. The counts, averages, and standard deviations included in the sample report 220 are those of particular features employed in handwriting analysis and useful in embodiments of the present invention for graphological detection of deception. Correlation coefficients are reported for each feature, the correlation coefficient representing the degree to which there is a change in the feature from the control input versus the test input. For example, a correlation coefficient of 1 for a particular handwriting feature would imply no change at all in that feature, from it's presence in the control input versus the test input; while a correlation coefficient very close to 0 would represent a very significant change. Typically, any feature with a correlation coefficient less than 0.9 will be worth noting.

One particularly notable change is the change in middle zone size, from an average of 2.94 with 0.24 standard deviation in the control input, to an average of 2.48 with 0.5 standard deviation in the test input. This yields a correlation coefficient of 0.24, indicating significant change in the middle zone size of the control input versus the test input. This significant change is indicative of deception in the test answers.

FIG. 3 is a table 300 of features of handwriting on which analysis of handwriting input to generate control and test handwriting feature data is based in some embodiments. As discussed above, graphology is the study of handwriting, and this study is carried out in terms of particular features exhibited in the handwriting. There are hundreds of features that have been defined and used in the analysis of handwriting. Table 300 includes the most prominent features utilized in embodiments of the present invention. It is understood that additional features, as known in the art, can readily be included without departing from the scope of this disclosure. The features listed in the table 300 are now described.

The use of space 302 typically refers to the space between words. The standard for the use of space between words is the width of one handwritten letter (as written by the subject). In some circumstances, spaces between letters in a word may be of note, particularly if the writing of that word is cramped or expanded compared with the other words in the handwriting. Often the spacing between lines is included in the analysis of handwriting, provided the sample was written on unlined paper.

The size of the handwriting 304 includes the sizes of the individual upper, middle, and lower zones. A size of 3 mm for each of the individual zones is generally taken as the standard, with an overall 9 mm as the standard of size for handwriting. As known to those skilled in the art, the upper zone is that portion of the handwriting that includes the upper portions of the tall letters, b, d, f, h, k, l, and t. The lower zone includes the lower portions of letters with descenders, f, g, j, p, q, y, and z. The middle zone includes in their entirety letters such as, for example, a, e, r, m and c. It will be appreciated that the invention is not limited to handwritten English, and that the methods of handwriting analysis for detection of deception as descried herein can also be applied to other languages, for example, French and Spanish (both of which use a cedilla), Greek, and non-Western languages.

The slant 306 of the handwriting includes both letter slant, for example, for the letters b, d, f, h, k, l, and t, and baseline slant. In standard graphology rightward slant is taken to be indicative of responsiveness, leftward slant suggests reserve, and no slant is taken to indicate independence. In embodiments of the present invention, of course, features have meaning when there are discernable differences between control input and test input that indicate deception.

Connective forms 308 of the handwriting include garlands, arcades, angles, and threads. Garlands are connective forms that are curved at the bottom and open at the top, for example, like a cup. Arcades, in contrast, are connective forms that are curved on top and open at the bottom, like an arch. Connective forms that are angles include abrupt changes in direction. Threads are connective forms that may be sinuous, thinning, or diminishing, and these latter connective forms may be considered subclasses of threads. Changes between the control input and the test input between the kinds of connective forms used can be indicative of deception.

The level of pressure 310 applied during the handwriting can be a signal of stress. Level of pressure 310 affects line width, so a measure of applied pressure is the line width of a pen trace, for example, in number of pixels for scanned handwriting, or carefully measured under magnification in the case of manual processing. In conventional graphology, strong applied pressure may suggest commitment and seriousness, but excessive pressure can indicate impulsiveness and compulsiveness. Light pressure, on the other hand, can show sensitivity and empathy. Of course, as mentioned above, qualities associated with the level of pressure 310 are interpreted in embodiments of the present invention with reference to differences between the control input and the test input.

Whether the handwriting is printed or written in script 312 can indicate significant differences in a subject's willingness to disclose information, that is, to be forthcoming. Feature 312 can be reported, for example, as an overall percentage for the control answers and for the test answers. In addition, words that written in script in the control input but are printed in a test answer, or vice versa, can be identified and flagged.

Specific letter formations in the handwriting 314 can signal particular words that may be used deceptively. For example, in the sample report above, the letters ‘e’ and ‘r’ were singled out as indicators of deception in the words “have” and “every.” Again, specific letter formations 314 are significant in the context of the present invention where there are differences between the control answers and the test answers.

The form level 316 of the handwriting can be defined, informally, as an overall impression given by the handwriting. Form level 316 includes how the writing flows, that is, whether the handwriting seems fluid or broken. Form level 316 can also include other attributes such as overall legibility, symmetry and even rhythm of the handwriting. Moreover, in some samples of handwriting the form level 316 can indicate whether the writer seemed hurried or relaxed. In conventional graphology, high form level represents a high overall impression of the handwriting, while low form designates an overall low form of the handwriting. It will be appreciated that form level 316 can also be applied to the overall impression of an individual handwritten word.

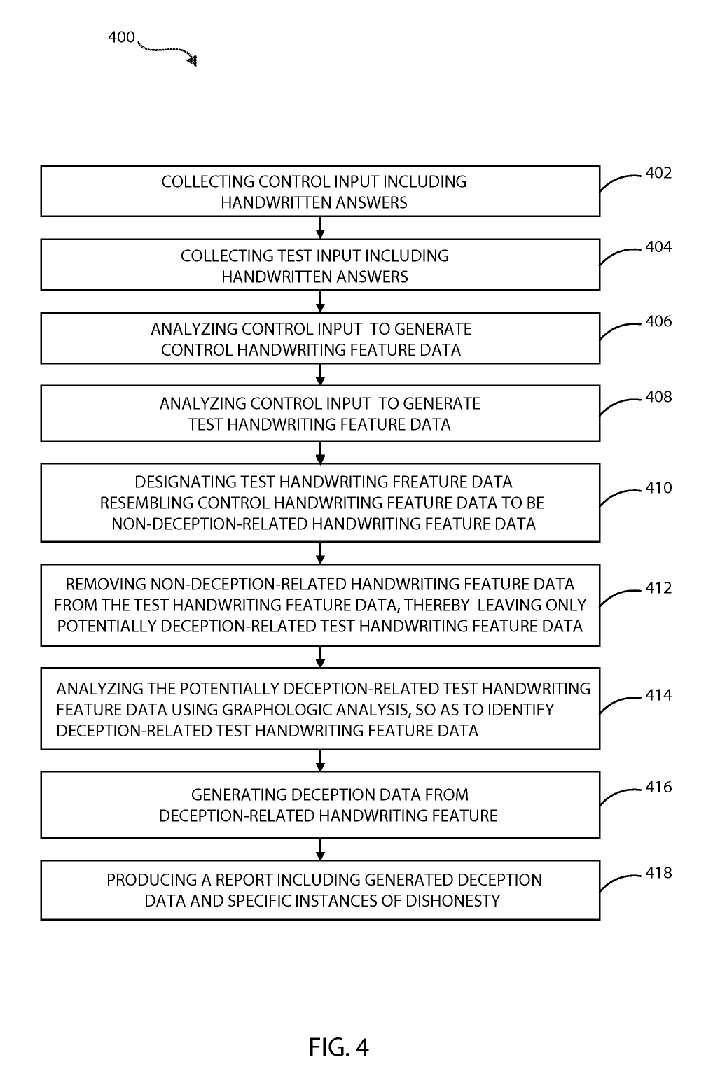

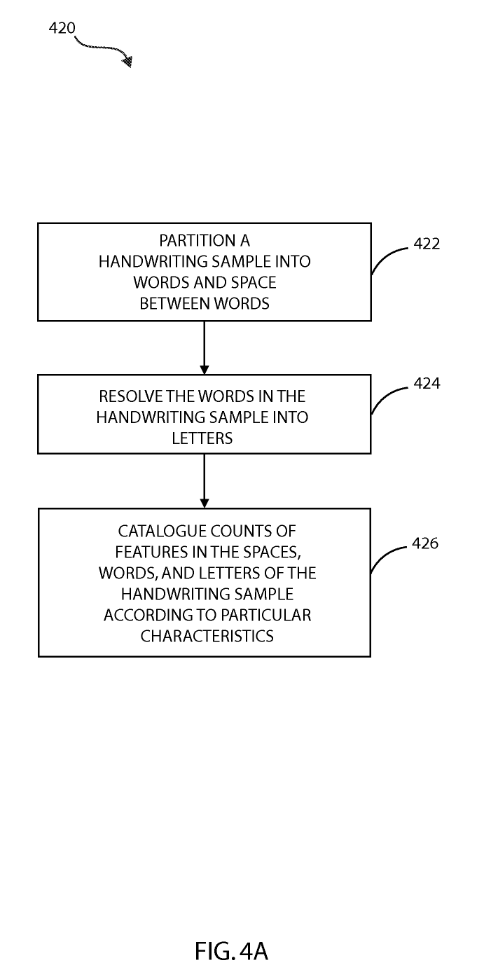

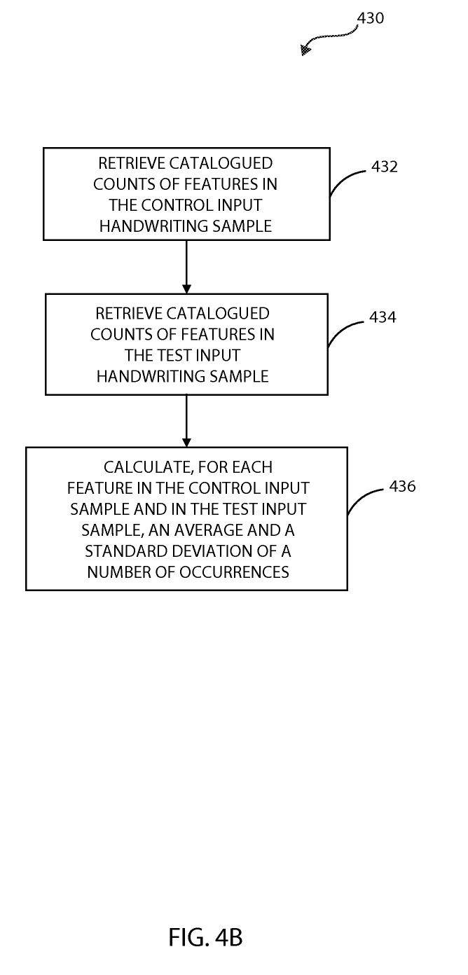

FIG. 4 is a flowchart of an embodiment of a method 400 for graphological detection of deception in handwriting of a subject. The method 400 includes a step 402 of collecting control input the subject, including handwritten answers to control questions, and a step of collecting test input from the subject, the test input including handwritten answers to test questions 404. It is understood that the steps 402 and 404 can be carried out in either order, or even with portions of the control input 208 interleaved with portions of the test input. It is also understood that the control input 208, as well as the test input, can be collected with an electronic writing tablet 104 on paper and processed manually, or scanned and processed with character recognition and other software.

The method 400 processes the collected inputs in steps 406 and 408. The step 406 of analyzing control input to generate control handwriting feature data, and the step 408 of analyzing test input to generate test handwriting feature data, can be accomplished in either order, or even concurrently. The analyzing 406 of control input to generate control handwriting feature data is configured to identify personality-based handwriting anomalies. The steps discussed below in connection with FIG. 4A for analyzing 408 the test input to generate test handwriting feature data can also be used in the analyzing 406 of the control input to generate control handwriting feature data, but the emphasis in the analysis of control input is to identify personality-based handwriting anomalies that represent inherent handwriting characteristics of the subject.

Once the control and test handwriting feature data are generated, the test handwriting feature data is compared with the control handwriting feature data to segregate non-deception-related test handwriting feature data from deception-related test handwriting feature data. This includes the steps of designating test handwriting feature data resembling control handwriting feature data to be non-deception-related handwriting feature data 410, and then removing non-deception-related handwriting feature data from the test handwriting feature data, thereby leaving only potentially deception-related test handwriting feature data.

Because of the comparison of the test handwriting feature data with the control handwriting feature data, the segregation of non-deception-related test handwriting feature data from deception-related test handwriting feature data takes account of inherent handwriting characteristics unrelated to deception. Without such account being taken, at least some inherent handwriting characteristics could be interpreted as indicative of deception, when in reality, for a particular subject that is not the case.

Next, the potentially deception-related test handwriting feature data is analyzed using graphological analysis 414, so as to identify deception-related test handwriting feature data. In this step, graphological analysis proceeds as it traditionally would, however it proceeds with the benefit of having filtered out the non-deception-related test handwriting data through comparison with control answer handwriting data.

The method 400 continues with a step 416 of generating deception data from the deception-related handwriting feature data. In various embodiments, the generated deception data indicates whether the test input is deceptive, that is, contains instances of dishonesty, based on the averages and standard deviations, for example, how different the averages (or averages per word or per letter) are between the control handwriting feature data and the test handwriting feature data, and/or based on identification of outliers discussed below. In certain embodiments, the generated deception data includes specific instances of dishonesty, whose locations can be identified in the test input using the handwriting mapping coordinates associated with the instances of dishonesty. In some embodiments, the method 400 further includes a step of producing a report 418 that can include the generated deception data as well as identifying specific instances of dishonesty.

FIG. 4A is a flowchart that provides further details 420 about steps 406 and 408 in FIG. 4, in particular, how control input can be analyzed to generate control handwriting feature data, and test input can be analyzed to generate test handwriting feature data;

The analyzing 408 is carried out in this embodiment by partitioning 422 the handwriting sample into words and spaces between words. This can be carried out manually, however, in various embodiments, the handwriting sample is in digital form (whether by scanning a paper sample or through use of a writing tablet 104 (see FIG. 1A)) and the partitioning 422 can be carried out on the digital data, with the aid of handwriting to text conversion but also retaining the digital handwriting data.

In a step 424 the words in the handwriting sample are resolved into letters, and once again this may be accomplished digitally. The spaces, the words, and the letters of the handwriting sample all provide feature information that can be quantified, for example, degree of slant, or the length of space between two specific consecutive words. In a step 426, counts and other appropriate measures of the features in the spaces, words, and letters of the handwriting sample are catalogued according to particular characteristics, for example, the features tabulated in table 300 of FIG. 3.

Locations identified, for example with handwriting mapping coordinates are retained for each feature as part of the cataloguing. Handwriting mapping coordinates may be considered as analogous to geographic mapping coordinates. For example, a page number of a set of scanned pages, and a set of pixel coordinates for a letter or space of the handwriting sample, may serve as handwriting mapping coordinates for the letter or space. The handwriting mapping coordinates are useful in connecting an identified instance of deception with its location in the test input.

FIG. 4B is a flowchart that provides further details 430 about step 410 in FIG. 4, in particular, determining which portion of test handwriting feature data resembles control handwriting feature data. The comparison of test handwriting feature data with control handwriting feature data is accomplished in this embodiment by retrieving 432 catalogued counts of features in the control input handwriting sample, and retrieving 434 catalogued counts of features in the test input handwriting sample. It is understood that the steps 432 and 434 can be carried in either order. Finally, the comparison 450 includes a step 436 of calculating, for each feature in the control input sample and in the test input sample, an average and a standard deviation of a number of occurrences. In this way, the comparison is performed by determining averages and standard deviations for counts of particular features tabulated in the control handwriting feature data and the test handwriting feature data. Significant differences between corresponding statistics for control input and for test input signal instances in the subject's handwriting that indicate deception.

Moreover, outlier detection can be applied to the test handwriting feature data based on the calculated averages. Since averages and standard deviations are at this point known for all the features identified in the control input and in the test input, the averages and standard deviations for the control handwriting feature data can be scaled, based for example on their respective word counts and letter counts, from the control handwriting feature data to the test handwriting feature data. Differences between the scaled control statistics and the test statistics indicate that outlier instances of features should be sought in either or both of the control handwriting feature data and the test handwriting feature data. Words in the test input that contain at least one outlier instance indicate deception. Words in the control input that contain at least one outlier instance suggest that the same word in the test input is indicative of deception if the same outlier instances are not present. It is understood that outlier instances of spaces between words or lines can be associated with the adjacent words or lines. Based in the outlier detection, non-deception-related test handwriting feature data is segregated from deception-related test handwriting feature data.

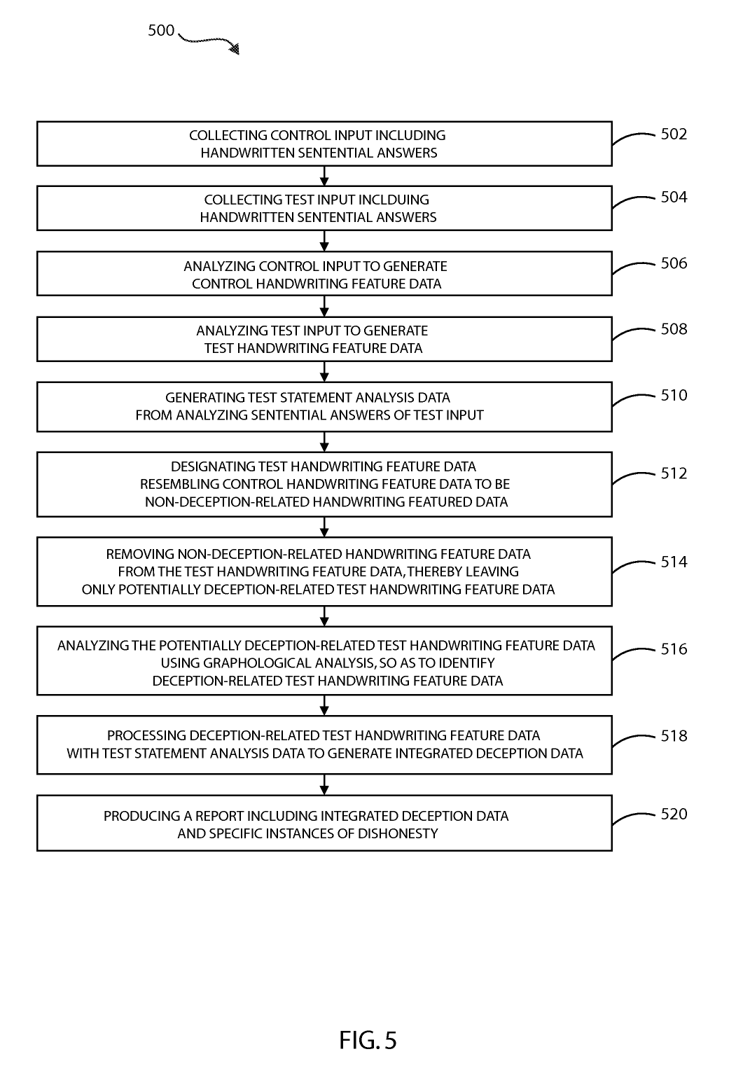

As mentioned in the Background Section, test statement analysis can support and strengthen the conclusions obtained via graphological detection of deception. FIG. 5 is a flowchart of an embodiment of a method 500 of the present invention for graphological detection of deception by a subject that integrates statement analysis with handwriting analysis to generate integrated deception data. The method 500 includes a step 502 of collecting control input from the subject, the control input including handwritten sentential answers to control questions on a questionnaire discussed previously, the control input can include the subject's handwritten answers to questions regarding the subject's name, date and/or place of birth, physical attributes (height, eye and hair color, etc.). Generally, it is preferable to have control questions that would be answered with sentential answers, to get more language and syntax information useful for statement analysis.

The method 500 also includes collecting test input from the subject that includes sentential answers to test questions. Sentential answers are answers which contain information in the grammar and semantics, including words used, that have a bearing on deception by a subject. Sentential answers can be analyzed via statement analysis, to generate deception data having a dimension beyond graphological analysis.

It is understood that the control input and test input can be collected with an electronic writing tablet on paper and processed manually, or scanned and processed with character recognition and other software. It is further understood that the steps 502 and 504 can be carried out in either order, or even with portions of the control input interleaved with portions of the test input.

The method 500 processes the collected inputs in steps 506 and 508. The step 506 of analyzing control input to generate control handwriting feature data, and the step 508 of analyzing test input to generate test handwriting feature data, can be accomplished in either order, or even concurrently. The analyzing of the control input 506, and analyzing of the test input 508 have already been discussed above in connection with FIGS. 4 and 4A.

In a step 510 the method generates test statement analysis data from analyzing sentential answers of test input. The generation of test statement analysis data includes some, but not all, aspects of the steps described in FIG. 4A for analyzing test input to generate test handwriting feature data. Moreover, many current word processing programs include routines that are capable of identifying syntactic features of text, and such routines can be adapted for test statement analysis.

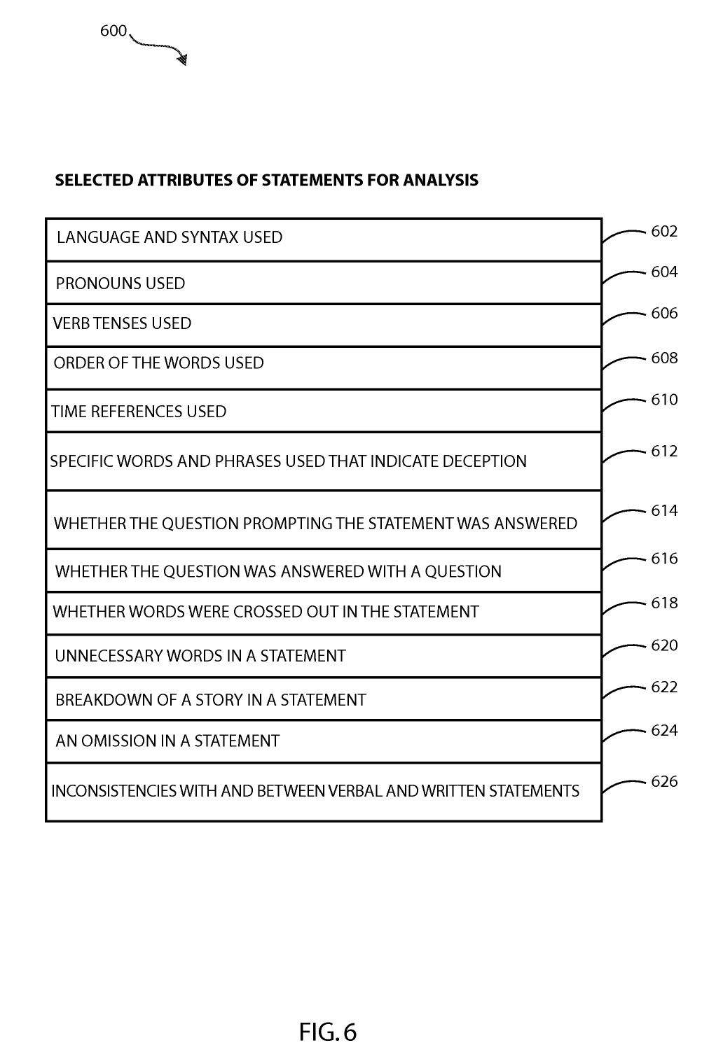

Further, natural language processing (NLP) is a relatively mature technology, sometimes considered as a form of artificial intelligence that can be applied to the task of generating test statement analysis data. For example, sentential answers are analyzed down to the granularity of word by word instances. As also discussed in relation to FIG. 4A, counts and other appropriate measures of the statement features in words and sentences of the handwriting sample are catalogued according to, and based on, particular characteristics, for example, the attributes tabulated in FIG. 6, discussed below.

Once the test statement analysis data and the test handwriting feature data are generated, the test handwriting feature data is compared with control handwriting feature data to segregate non-deception-related test handwriting feature data from deception-related test handwriting feature data. The sub-steps in the comparison have been discussed above in connection with FIG. 4B.

Test handwriting feature data that resembles control handwriting feature data is designated as non-deception-related handwriting feature data 512. This non-deception-related handwriting feature data is then removed from the test handwriting feature data, thereby leaving only potentially deception-related test handwriting feature data 514. Then, the potentially deception-related test handwriting feature data is analyzed using graphological analysis, so as to identify deception-related test handwriting feature data 516.

The method further includes a step 518 of generating integrated deception data from the deception-related handwriting feature data and the test statement analysis data. In various embodiments, the integrated deception data indicates whether the test input is deceptive, that is, contains instances of dishonesty, based on the averages and standard deviations, for example, how different the averages (or averages per word or per letter) are between the control handwriting feature data and the test handwriting feature data, and/or based on identification of outliers discussed above, and also based on the results of test statement analysis. In certain embodiments, the integrated deception data includes specific instances of dishonesty, whose locations can be identified in the test input using the handwriting mapping coordinates associated with the instances of dishonesty.

Integrated deception data includes instances of deception identified both by handwriting analysis, and by statement analysis. Integrated deception data in addition includes instances of deception identified by only one of handwriting analysis and statement analysis. Differences in instances of deception identified by only one of handwriting analysis and statement analysis can in addition be flagged for later interpretation.

The integrated deception data includes, as mentioned, the results of statement analysis of the test input. The integrated deception data also includes the results of handwriting analysis of the test input allowing for inherent characteristics of the subject's handwriting as determined from the control input. In certain embodiments, the integrated deception data includes specific instances of dishonesty. And in some embodiments (including the embodiment shown), the method 500 includes a step of producing a report 520 that can include the integrated deception data as well as identifying specific instances of dishonesty.

FIG. 6 shows a table 600 of attributes of statements, on which the generation of test statement analysis data is based in certain embodiments. Statement analysis is the study of an individual's statements, either oral or written, and is carried out in terms of particular attributes of the statements. Statement analysis includes analysis of words used and their meaning, and grammatical forms used. Table 600 includes the most prominent attributes of statement analysis incorporated in embodiments of the present invention. It is understood that additional attributes, as known in the art, can readily be included without departing from the scope of this disclosure. The attributes of statement analysis listed in the table 600 are briefly described.

The language and syntax used 602 can include, for example, passive voice in statements, which can indicate the subject wishing to dissociate himself from the content of the statement. Statement analysis also takes note of pronouns used 604. One example is the use of the first person pronoun “I” in one part of an account of an event, and then a switch to use of “we,” later in the account. Also, deviations of pronoun use throughout the text can signal deception. Another, related, example is use of a person's name where previously another term was used, for example, “my friend.” It is understood that use of pronouns can include use of possessive pronouns as well as personal pronouns.

How verb tenses are used 606 is another attribute examined in statement analysis. Examples include past tense versus present tense, a change in the tense used, the use of “had” vs. “have,” and the use of “would have.” Attention is also paid to the order of the words used 608, as a careful choice of word order may indicate an attempt to conceal. A careless choice of word order is also a deviation from the norm, and may in particular circumstances indicate a subject's desire to conceal. Moreover, if time references used 610 are out of order, for example, this can indicate that an account is impromptu, rather than an account of a recalled event, and thus deceptive. Furthermore, there are specific words and phrases 612 used that indicate deception; examples include “if possible,” “I'll try,” and “I believe,” for instance.

Whether the question prompting the statement was answered 614 is a clue to a subject's intent to deceive. In addition, whether the question was answered with a question 616 is similarly suggestive of an attempt to deceive. Also, whether words were crossed out in the statement 618 can be a sign of deception, since crossing out of words indicates intent to change the impression made by a statement.

Sometimes a subject's response will include “filler,” that is, unnecessary words 620 in a statement. A widespread example is the short phrase “you know.” Another indication of deception is the breakdown of a story in a statement 622. For example there may be inconsistent statements or clauses within the subject's written or spoken answers. Another attribute that can suggest or indicate deception is an omission in a statement 624. A particular detail, for example, may be left out. The omitted detail may be one that would change the impression left by the story, or may even incriminate the subject.

Whether there are inconsistencies with and between verbal and written statements 626 often can be determined, especially in the case where an interview is recorded. Even without a speech recorder, written notes of the interviewer can show conflict between a written response of the subject and a spoken response. A situation in which this may arise is, for example, where the interviewer may ask a question that is identical, or nearly so, to a question on a questionnaire filled out by the subject.

It will be appreciated that statement analysis as described above is applied to test input. It can also be applied to control input, although instances of deception, and/or intent to deceive, would not be expected in the control answers. An embodiment of a method of graphological detection of deception that incorporates statement analysis is discussed above in connection with FIG. 5. An embodiment of a method of graphological detection of deception that need not incorporate statement analysis is illustrated in FIG. 4, as discussed above.

It is understood that steps of the methods described above can be practiced without the benefit of automation. It will be appreciated that with the availability of text recognition software, handwriting recognition software, and even speech to text capability of software applications, practice of the present invention is not limited to manual execution or manual performance of steps of the above described method embodiments. One aspect of the present invention is a computer system capable of carrying out the steps of the methods previously discussed.

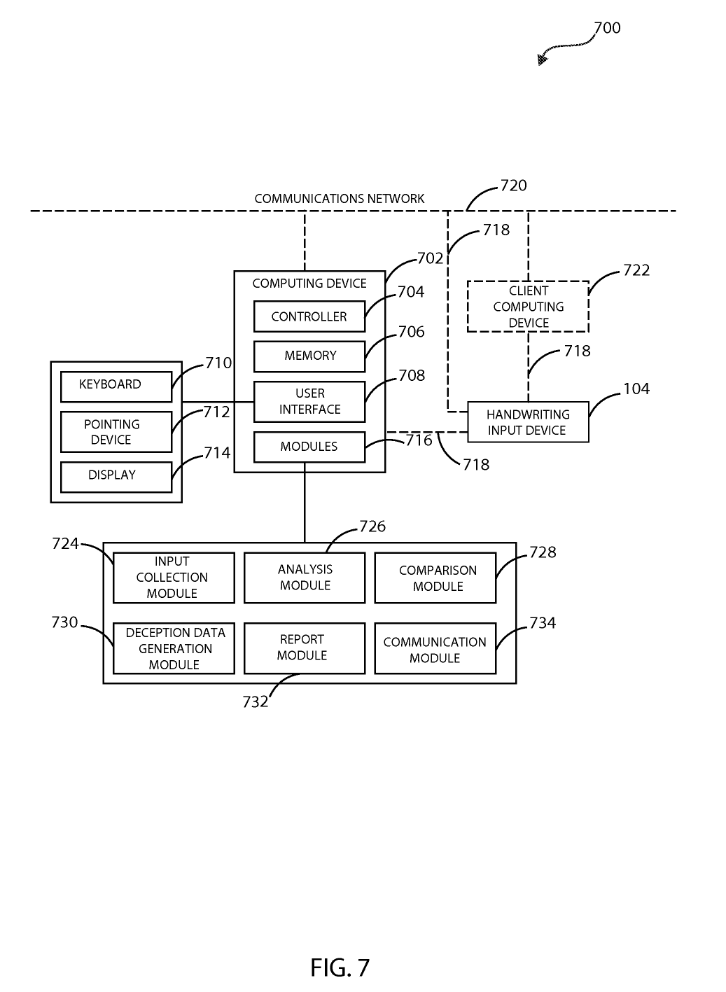

FIG. 7 is a block diagram of an embodiment of a system 700 for graphological detection of deception, showing a computing device 702 including a user interface 708 and software modules 716, and a handwriting input device 104 for capture of handwriting in response to questions, for example, of an interviewer. The computing device 702 also includes a controller 704 coupled with the user interface 708. The computing device 702 in addition includes memory 706 coupled to the controller 704 and configured to store instruction modules, for example, modules 716, for execution by the controller. The memory 706 may be implemented as RAM, mass storage, flash memory, and/or other memory technologies as known in the art.

The system 700 includes one or more connections to the handwriting input device 104. A connection could be made directly via for example a cable or wireless connection 718, or via a company's intranet or other communications network 720 coupled to the computing device 722. In some embodiments, the communications network 720 can provide connection 718 to the handwriting tablet 104, for example, through a separate client computing device 738. In some embodiments having a separate client device 722, the computing device 708 is a server for the client device. In certain embodiments, the handwriting tablet 104 itself includes sufficient computing power to manage communication protocols and even carry out additional processing. It is understood that any manner of connection known in the art, between the handwriting input device 104 and the computing device 708, is within the scope of this disclosure. It will further be appreciated that the electronic handwriting input device 104, coupled to the computing device 702, is configured to electronically capture handwriting, and includes at least one of an electronic writing tablet capable of registering pressure applied in the handwriting, and a scanner.

The user interface 708 of the computing device 702 includes a keyboard 710, a pointing device 712, and a display 714. The pointing device 712 can be, for example, a mouse, trackball, touchpad, or other pointing device as known to those skilled in the art. The display 714 can include a standalone display, a display incorporated with a computer, as, for example, with a laptop computer, and/or the display 714 can include a projection device. It is understood that the user interface 708 can include additional user interface components as known in the art. Interview questions may be presented to the subject directly by the interviewer, or the interview questions may be presented on the display 714, or a combination of the two types of presentation may be employed.

As discussed above, the computing device 702 includes a set of modules 716. The modules 716 can be implemented in software or in hardware as appropriate to accomplish the functions described above in connection with FIGS. 4, 4A, 4B, and 5. The modules 716 include an input collection module 724 which includes instructions to collect both control input and test input, in accordance with the steps 402 and 404 described above in connection with FIG. 4, and in accordance with steps described above in the discussion of FIG. 5. An analysis module 726 includes instructions to carry out the steps of analyzing control input to generate control handwriting feature data, and the steps of analyzing test input to generate test handwriting feature data, as described above in connection with FIGS. 4 and 5.

The modules 716 also include a comparison module 728 with instructions that implement the steps 410, 412, 414 involved with comparing test handwriting feature data with control handwriting feature data to separate non-deception-related handwriting feature data from potentially deception-related handwriting feature data. Also included are a deception data generation module 730, a report module 732, and a communication module 734.

The deception data generation module 730 includes instructions configured to process the deception-related test handwriting feature data to generate deception data, as discussed above. Moreover, in some embodiments, the deception data generation module 730 may in addition include instructions to carry out some analysis functions to accomplish step the analyzing control input to generate control handwriting feature data.

The report module 732 includes instructions to produce a report, for example, report 220 (see FIG. 2A) that can include generated deception data (see, for example, FIG. 2B) along with specific instances of deception, discussed above in connection with FIG. 4 and FIG. 5. The communication module 734 has instructions to manage some of the communication tasks with peripheral devices like the handwriting tablet 104, and/or with the communications network 720.

As discussed above, the invention is a method and system for graphological detection of deception. The method collects and compares test input from a subject with control input provided by the subject, to take account of features of the subject's handwriting that are not deception-related. In certain embodiments of the invention, the collection of input is accomplished with a handwriting input device that can provide digital output. Many of the steps of the methods of the present invention can be accomplished in hardware and/or software. In some embodiments, a computer system to implement methods of the present invention is provided.

Other modifications and implementations will occur to those skilled in the art without departing from the spirit and the scope of the invention as claimed.

Accordingly, the above description is not intended to limit the invention except as indicated in the following claims.

What is claimed is:

1. A method for enhanced graphological detection of deception by a subject, the method comprising:
collecting control input from the subject, the control input including handwritten answers by the subject to control questions;
collecting test input from the subject, the test input including handwritten answers by the subject to test questions;
analyzing the control input to generate control handwriting feature data;
analyzing the test input to generate test handwriting feature data;
designating test handwriting feature data resembling control handwriting feature data to be non-deception-related test handwriting feature data;
designating test handwriting feature data not resembling control handwriting feature data to be potentially deception-related test handwriting feature data;
analyzing the potentially deception-related test handwriting feature data using graphological analysis, so as to identify deception-related test handwriting feature data; and
generating deception data from the potentially deception-related test handwriting feature data.

2. The method of claim 1, wherein the generated deception data includes specific instances of dishonesty.

3. The method of claim 1, wherein analyzing the control input includes identifying personality-based handwriting features.

4. The method of claim 1, further comprising:
collecting the control input and the test input through at least one of:
a paper form; and
an electronic writing tablet.

5. The method of claim 1, wherein:
control handwriting feature data and test handwriting feature data are generated based on a set of selected handwriting features,
the set of selected features including at least one of:
use of space;
size of handwriting including upper, middle, and lower zones;
slant of the handwriting;
connective forms of the handwriting;
detection of a level of pressure applied during the handwriting;
whether the individual prints or writes in script;
specific letter formations in the handwriting; and
form level of the handwriting.

6. The method of claim 5, wherein detection of the level of pressure includes determining a width measurement of a pen trace in handwritten answers to control questions and test questions.

7. The method of claim 1, wherein:
test handwriting feature data resembling control handwriting feature data is identified by determining averages and standard deviations for counts of particular features tabulated in both the control handwriting feature data and in the test handwriting feature data.

8. The method of claim 1, further comprising:
producing a report, the report including generated deception data that includes specific instances of dishonesty.

9. A method for enhanced graphological detection of deception by a subject, the method comprising:
collecting control input from the subject, the control input including handwritten sentential answers by the subject to control questions;
collecting test input from the subject, the test input including handwritten sentential answers by the subject to test questions;
analyzing the control input to generate control handwriting feature data;
analyzing the test input to generate test handwriting feature data;
designating test handwriting feature data resembling control handwriting feature data to be non-deception-related test handwriting feature data;
designating test handwriting feature data not resembling control handwriting feature data to be potentially deception-related test handwriting feature data;
analyzing the potentially deception-related test handwriting feature data using graphological analysis, so as to identify deception-related test handwriting data;
analyzing the sentential answers of the test input so as to generate test statement analysis data; and
generating integrated deception data via integration of the deception-related test handwriting feature data with the test statement analysis data.

10. The method of claim 9, wherein the integrated deception data includes specific instances of dishonesty.

11. The method of claim 9, wherein analyzing the control input includes identifying personality-based handwriting anomalies.

12. The method of claim 9, further comprising:
collecting the control input and the test input through at least one of:
a paper form; and
an electronic writing tablet.

13. The method of claim 9, wherein control handwriting feature data and test handwriting feature data are generated based on a set of selected handwriting features,
the set of selected features including at least one of:
use of space;
size of handwriting including upper, middle, and lower zones;
slant of the handwriting;
connective forms of the handwriting;
detection of a level of pressure applied during the handwriting;
whether the individual prints or writes in script;
specific letter formations in the handwriting; and
form level of the handwriting.

14. The method of claim 9, wherein test statement analysis data is generated based on a set of selected attributes,
the set of selected attributes including:
language and syntax used by the subject in a statement;
pronouns used by the subject in a statement;
verb tenses used by the subject in a statement;
order of the words in a statement of the subject;
time references in a statement of the subject;
specific words and phrases that indicate deception in a statement of the subject;
whether the subject answered the question in his or her statement;
whether the subject answered with a question in his or her statement;
whether the subject crossed out words in a statement;
unnecessary words in a statement of the subject;
breakdown of a story in a statement of the subject;
an omission in a statement made by the subject; and
inconsistencies with and between verbal and written statements of the subject.

15. The method of claim 9, further comprising:
producing a report, the report including integrated deception data that includes specific instances of dishonesty.

16. A system for graphological detection of deception by a subject, the system comprising:
a computing device, the computing device including:
a controller configured to execute instructions;
a memory coupled to the controller and configured to store instruction modules for execution by the controller;
an input collection module coupled to the controller, the input collection module having instructions to collect control input and test input from a subject, the control input including handwritten answers to control questions and the test input including handwritten answers to test questions;
an analysis module coupled to the controller, the analysis module having instructions to analyze control input to generate control handwriting feature data, and analyze test input to generate test handwriting feature data,
the analysis module also capable of analyzing potentially deception-related handwriting feature data using graphological analysis, so as to identify deception-related handwriting feature data;
a comparison module,
the comparison module being coupled to the controller and having instructions to compare test handwriting feature data with control handwriting feature data,
so as to designate test handwriting feature data resembling control handwriting feature data to be non-deception-related test handwriting feature data, and
designate test handwriting feature data not resembling control handwriting feature data to be potentially deception-related test handwriting feature data; and
a deception data generation module coupled to the controller and having instructions to process deception-related test handwriting feature data identified by the analysis module, so as to generate deception data; and
an electronic handwriting input device coupled to the computing device, the electronic handwriting input device configured to electronically capture handwriting, the electronic handwriting input device including at least one of:
a scanner, and
an electronic writing tablet capable of registering pressure applied in the handwriting.

17. The system of claim 16, further comprising:
a report module coupled to the controller,
the report module having instructions to produce a report,
the report including generated deception data that includes specific instances of dishonesty.

18. The system of claim 16, wherein the computing device includes a communication module,
the communication module coupled to the controller,
the communication module capable of providing communication between at least one of peripheral devices and a communications network; and
a user interface coupled to the controller and including a keyboard input device, a pointing device, and a display device.

19. The system of claim 16, wherein the electronic handwriting input device is coupled to the computing device via a communications network.

20. The system of claim 16, wherein the computing device is a server,
the server being coupled to the electronic handwriting input device via a client computing device.

21. A system for graphological detection of deception by a subject, the system comprising:
an electronic handwriting input device, the electronic handwriting input device configured to electronically capture handwriting of a subject; and
a computing device coupled to the electronic handwriting input device, the computing device configured to:
collect control input from the subject, the control input including handwritten answers by the subject to control questions;
collect test input from the subject, the test input including handwritten answers by the subject to test questions;
receive the control input and the test input from the electronic handwriting input device;
analyze the control input to generate control handwriting feature data;
analyze the test input to generate test handwriting feature data;
designate test handwriting feature data resembling control handwriting feature data to be non-deception-related test handwriting feature data;
designate test handwriting feature data not resembling control handwriting feature data to be potentially deception-related test handwriting feature data;
analyze the potentially deception-related test handwriting feature data using graphological analysis, so as to identify deception-related test handwriting feature data; and
generate deception data from the potentially deception-related test handwriting feature data.
